(19) United States
(12) Patent Application Publication
(10) Pub. No.: US 2014/0172208 A1
(43) Pub. Date: Jun. 19, 2014

(54) METHOD FOR CONTROLLING THE RECUPERATION BEHAVIOUR IN A MOTOR VEHICLE AND MOTOR VEHICLE

(71) Applicants: Reimund Limbacher, Ingolstadt (DE); Alexander Kruse, Ingolstadt (DE); Thomas Urban, Rennertshofer (DE); Manfred Dietrich, Kosching (DE); Andreas Muigg, Ingolstadt (DE)

(72) Inventors: Reimund Limbacher, Ingolstadt (DE); Alexander Kruse, Ingolstadt (DE); Thomas Urban, Rennertshofer (DE); Manfred Dietrich, Kosching (DE); Andreas Muigg, Ingolstadt (DE)

(73) Assignee: Audi AG, Ingolstadt (DE)

(21) Appl. No.: 13/985,790

(22) PCT Filed: Aug. 2, 2011
(86) PCT No.: PCT/EP11/03862

§ 371 Date: Oct. 28, 2013

(30) Foreign Application Priority Data
Feb. 16, 2011 (DE) 10 2011 011 335.2

(51) Int. Cl. B60W 10/08; B60W 50/08; B60W 30/18

(52) U.S. Cl. CPC B60W 10/08; B60W 30/18; B60W 50/08; Y10S 903/902
USPC 701/22; 180/65.285; 903/902

(57) ABSTRACT

For controlling a recuperation behavior in a motor vehicle having a hybrid drive or an electric drive, a basic value of a recuperation torque which is to be used for recuperation is predefined and/or can be set by at least one first operating element, a second operating element is used to set an intermediate value deviating from a basic value for the recuperation torque, after the intermediate value has been set by an operator temporarily, in particular for at least one coasting phase, the intermediate value is used as a recuperation torque, after which switching back to the basic value occurs where a resetting operation is entered.

The invention relates to a method for controlling the recuperation behavior in a motor vehicle with a hybrid drive or an electric drive, wherein a basic value of a recuperation torque to be used for recuperation is predefined and/or is adjustable by at least one operating element.

Vehicles with hybrid drives, which include also an electric machine, or even pure electric vehicles are known. Usually they include vehicles with a hybrid internal combustion engine and an electric machine, wherein the internal combustion engine is operated with a fuel and the electric motor is usually associated with a battery.

In motor vehicles having a hybrid drive, as well as in motor vehicles with an electric motor, it is possible to recover a high part of braking energy. This process of the recovery of energy is commonly referred to as recuperation. The electric machine is operated as a generator with a specific recuperation moment to charge the battery.

The recovery of energy, thus the recuperation, is possible on the one hand during active braking, on the other hand in coasting operation. In this case, the coasting operation (in contrast to the pull operation) is the state of the motor vehicle, in which the internal combustion engine of the vehicle is not actively driven, the driver thus releases the accelerator pedal. Then, the vehicle as a result is driven forward only by its inertial mass, until diverse driving resistances gradually decelerate it to a standstill. These driving resistances include the recuperation torque, which ultimately represents a braking contribution in the coasting operation. When many driving resistances are eliminated, for example an engine braking by the internal combustion engine avoided and no recuperation carried out, then this driving condition is called moreover sailing operation.

Drivers usually have different preferences regarding the level of recuperation torque. Therefore possibilities have been proposed to make the level of the recuperation torque adjustable by a driver. Such a process is known for example from DE 10 2007 035 424 A1. It deals with a user interface that will allow the driver as often and easily as possible, to carry out the driving state of sailing. Here it is also described that the strength of the recuperation can be selected with a switch or actuator. It is also proposed to provide a continuously selectable setting of the recuperation torque. In other words, the coasting recuperation strength is fixedly adjusted to a basic value.

This approach is disadvantageous in that drivers often want a situational adjustment of the recuperation strength. With tight curves or more decelerated front vehicle often it is set to the maximum recuperation moment. If the adjustment remains this way, it comes on the other hand again to driving situations in which the driver is negatively surprised by the unexpected high deceleration in the coasting phase. An adaptation of the recuperation is therefore often desired only situationally.

The invention is therefore based on the object to allow an operator adjustment of the recuperation torque in more intuitive and easier way.

To achieve this object, in a method of the type mentioned above it is provided that a second operating element is used for adjustment of an intermediate value for the recuperation torque, which is different from the main value, whereby after adjustment of the intermediate value by an operator temporarily, in particular at least for the next coasting phase, the intermediate value is used as recuperation torque, after which it is switched back to the basic value with entry of a resetting condition.

The invention therefore proposes to supplement the basic adjustment of recuperation, or the adjustment to a basic value, through a situational, temporary acting correction option that is ideally is possible via a fast to be reached second operating element. A momentary situation-dependent adaptation of recuperation is possible that can be immediately experienced on one hand for the driver, on the other hand due to the restoring conditions applies only to the situation for which it was elected, without later, when it was long forgotten, to ensure for surprising, unwanted moments. It is a type of temporary fine correction that after the end of the situation—in particular after the end of the next coasting phase—is again ended, being used purely situationally. The driver to this distance is capable, for example, when moving to a narrower curve to adjust a greater recuperation torque, with which a greater braking action is adjusted, but which after the narrow curve for the next possibly occurring coasting phase is no longer valid, so that then again from basic value starting if necessary a correction can be made. Similarly it is conducted for example whenever there is a hit from behind on a motor vehicle, while more or less braking action is required by the recuperation torque. Even the adjustment of a sailing operation for a temporary period is possible without problems. The driver, who can evaluate and assess situations well, whether he needs for a particular situation a lesser or greater recuperation torque, has a means available to adjust this exactly for the desired situation (and no longer).

In a further embodiment of the present invention it can be provided that the end of a coasting phase and/or the non-occurrence of a further coasting phase in a predetermined latent time after the end of a coasting phase is used as a resetting condition. It can therefore be provided that the end of the next coasting phase and the current coasting phase immediately cancels the change in the recuperation torque to the intermediate value and the basic value is restored. However, it is preferred to link the end of the situation to the non-occurrence of a further coasting phase in a predetermined latent time after the end of a coasting phase, so that also a short-term interruption of the coasting phase, for example, by active braking, and/or a short-term acceleration is provided, not as indication of the completion of the situation is considered, for which the intermediate value was adjusted by the driver. Such a latent time can be, for example, five to ten seconds, preferably six seconds in length.

In a particularly advantageous embodiment of the present invention it can be provided that an adjustment of an intermediate value is possible only in presence of an adjustment condition and/or the adjustment to the intermediate value only for a predetermined adjustment time or at least the duration of initiated within the adjustment time next coasting phase or already current coasting phase is maintained. With the two options described here is to be achieved, that not an accidental or not tangible adjustment of recuperation moment to the intermediate value can occur, for example, when in the foreseeable time no coasting phase occurs.

Consequently, it can be provided in a first alternative embodiment that an adjustment condition must exist to allow at all an adjustment of the intermediate value. It is possible to use as adjustment condition the actual existence of a coasting phase and/or the previous occurrence of the coasting phase in a predetermined previously determined time. It is advantageous if the imminent predetermination of a coasting phase can be predicted already, and therefore can be predicted with a certain security that a coasting phase follows. For this purpose it may be provided, for example, that the imminence of a coasting phase occurs in dependence on predictive route data and/or data on a forward-driving motor vehicle and/or data on a speed limit. If, for example, there is a curve before, which can be determined from predictive route data, so it can be assumed that a coasting phase can occur. Similarly, the behavior of a forwardly running motor vehicle can be observed, and when it slows down or brakes, an early coasting phase is possible. Finally, speed limits can be monitored either on the basis of the supplemented by map data predictive route data or by a traffic sign recognition. Then directly when the speed limit changes, the braking torque of a coasting phase is often used to adapt to the new speed. Then always the second operating element can be ultimately “cleared” shortly before a possible coasting phase.

In this embodiment, in which the adjustment of the intermediate value over long distances out is not possible, the inventive method can be made especially advantageous in that the operation of the second control element is blocked in the absence of the adjustment conditions, in particular the second operating element is locked. In this way is given to the driver to recognize haptically that at the time a change in the recuperation torque would not be possible/not recommended. In this way “learns” the driver also the function and scope of use of the second operating element easier and more intuitive. For example with this second operating element formed as a lever, its activation can be locked.

As already described, it is alternatively or additionally also conceivable that the adjustment to the intermediate value is maintained only for a predetermined adjustment time or at least the duration of the next coasting phase started within the adjustment period or already current coasting phase is maintained. With operation of the second control element it is then first checked whether there is already a current coasting phase. If this is the case, the adjustment is retained until the occurrence of the restoring condition. If actually there is no coasting phase before, the adjustment period begins to run.

If this expires before a coasting phase is started, the correction of the recuperation torque is rejected. However if a coasting phase begins within the adjustment time, then the recuperation torque adjusted on the intermediate value recuperation is used, until the resetting condition occurs. The adjustment time can be for example three to six seconds. It was at this point again noted that both options can also be combined with one another advantageously. For example, even when in the coasting phase, the second operating element is released for adjustment of the recuperation torque to the intermediate value, an adjustment time starts to run as it may happen that no coasting phase is released by the drivers operation. Moreover, it is also conceivable to choose the latent time, if provided, and the adjustment time the same and thus ultimately to combine.

As already mentioned, it can be provided in a further advantageous embodiment of the present invention that the second operating element arranged while driving by the driver in an ergonomically accessible position is used, in particular an operating element disposed in the area of the steering wheel and/or a shift lever and/or a foot pedal. When it comes to a situational correction of the recuperation torque, the second operating element must be reachable by the driver ergonomically and fast, so that it can react fast to a particular driving situation in which he desires a changed recuperation torque.

It has proved to be particularly advantageous when as the second operating element, a switch and/or switching lever on the steering wheel and/or on the steering column is utilized, in particular a switching rocker. Particularly preferred are switching rockers, frequently referred to “paddles”, that can be placed in the area of the crossbar of the steering wheel, where they are easily accessible for the finger of a driver holding the steering wheel. The switching rockers can be arranged so that they rotate with the steering wheel or can be arranged fixed on the steering column.

For example, a left and a right switching rockers can be provided as second operating elements, and each of the switching rockers is assigned to an increase or a decrease in the recuperation torques starting from the basic value.

Such switching rockers are otherwise known in motor vehicles, where these switching rockers are used for switching various gears (Tiptronic). From this, for electric drive an intuitive analog positioning and use for the driver can take place. It can therefore be provided that with an electric drive an operating element used in a shiftable motor vehicle as a gear selection operating element can be used as the second operating element. Here there is a clear analogy, because a Tiptronic switching is often used to produce an engine braking by switching down. Consequently, it is proposed to replace in an electric drive the operation selector switch with the second operating element, so that the driver finds intuitively similar operating possibilities in a similar position.

It should also be noted at this juncture that it is also possible for motor vehicles with hybrid drives, for example plug-in hybrids that via a further operating element by the driver its type can be selected according to whether it can use a particular operating element, for example two arranged switching rockers as described, as a second control element according to the present invention or as gear selection operating element.

In principle, it can be provided that the recuperation torque is ultimately continuously freely selectable, for example within a predetermined range. A period of operation of the second operating element or the like can then be used to determine how far the recuperation torque is to be lowered, that is, how much the intermediate value deviates from the basic value. Preferably, however, it is within the scope of the present invention, when the recuperation moment is adjustable to at least two different, predetermined values, in particular at least four different values including a value of zero for a sailing operation. In this case, the recuperation moment is gradually adjustable to specific, predefined values, for example in the case of four adjustment possibilities a value of zero for a sailing operation, a lower, a middle and a strong recuperation torque.

In an advantageous further embodiment of the invention it can be provided that with a gradual adjustment of the recuperation torque only an intermediate value can be adjusted which deviates by one step from the basic value. In this case, only defined deviations from the basic value are permitted, for example by an adjustable step. If in this case here steps are provided, as a basic value for example a middle recuperation torque is predefined, then by operation of the second operating element either differently a small recuperation torque or a high recuperation torque can be adjusted as an intermediate value, but not the recuperation torque of zero. In this way, too strong deviations differences in driving style are avoided.

Furthermore, it can be provided that the adjustment of the basic value is performed by the adjustment of an operating mode of the motor vehicle, especially a sport mode and/or comfort mode and/or a normal mode and/or an energy-saving mode, and/or the user freely selects the basic value, in particular via a menu displayed on a man-machine interface. The basic value can be also carried out via coupling to an operating mode. In the example of four stages of the recuperation torque described above a coordination for example can be provided, that in a power-saving operation mode a recuperation torque of zero is provided (sailing), in a comfort mode a weak recuperation is provided, in a normal mode a medium recuperation and in a sports operating mode a high recuperation torque value. In this case, the basic value of the recuperation torque is incorporated for example in an operating parameters package associated with a particular driving style. Alternatively, it is of course also possible, to make the basic value—especially in allowable range—freely selectable, for example via an adjustment menu in a man-machine interface.

It is also expedient if the actual adjustment of the basic value and/or the intermediate value is brought to a driver for display. For example an appropriate display can be provided in the instrument panel or a multi-function display can be provided, and the basic value can be displayed in a particular color, for example, on a scale, and a deviation in a different color, possibly in red, so that base value and intermediate value are readable in a single representation. Of course, other possibilities for display are also conceivable. So the driver in addition to the perceptibility of situational adjustment obtains an information via the actual adjustments.

In addition to the method, the invention also relates to a motor vehicle with a hybrid drive or an electric drive, including a driving control device and a second operating element for adjustment of an intermediate value for a recuperation torque, which is carried out to perform the inventive method. All embodiments with respect to the inventive method can be applied analogously to the motor vehicle according to the invention, by means of which the advantages achieved with the invention can thus be realized.

Such a motor vehicle covers an electric machine, which can be operated as a generator in a coasting phase with a defined recuperation torque, and a control is performed by said drive control device. Basically, a basic value is used for the amount of the recuperation torque, wherein however upon actuation of the second operating element an intermediate value can be adjusted, which is temporarily used instead of the basic value. It is moreover particularly advantageous when the second operating element is designed as at least one switching rocker provided on a steering wheel.

Further advantages and details of the present invention will become apparent from the hereinafter described embodiments and the drawings. In the drawings:

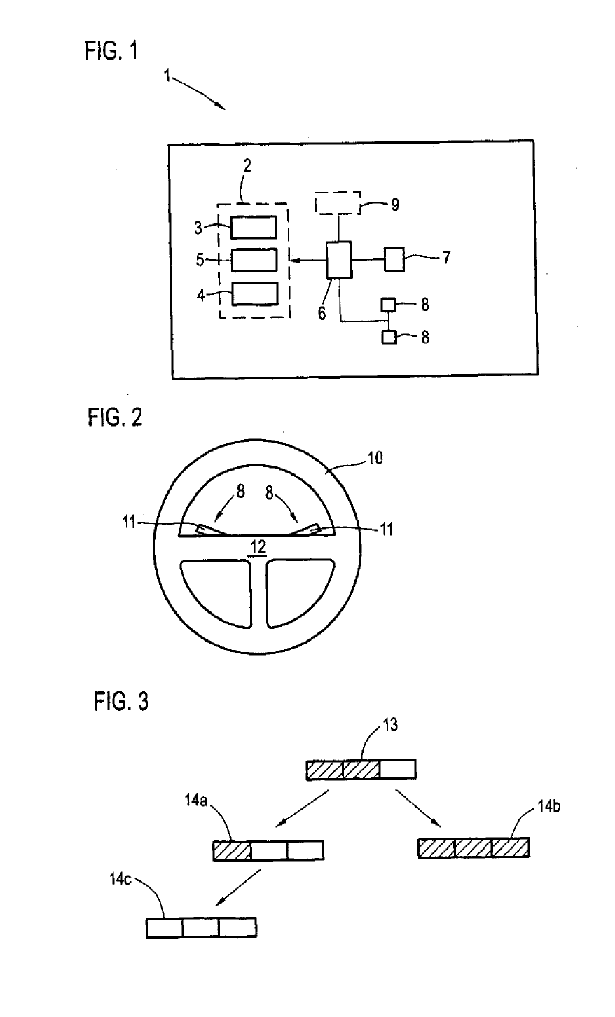

FIG. 1 is an inventive motor vehicle,

FIG. 2 is a steering wheel with the second operating element,

FIG. 3 is a sketch of action of the second operating element,

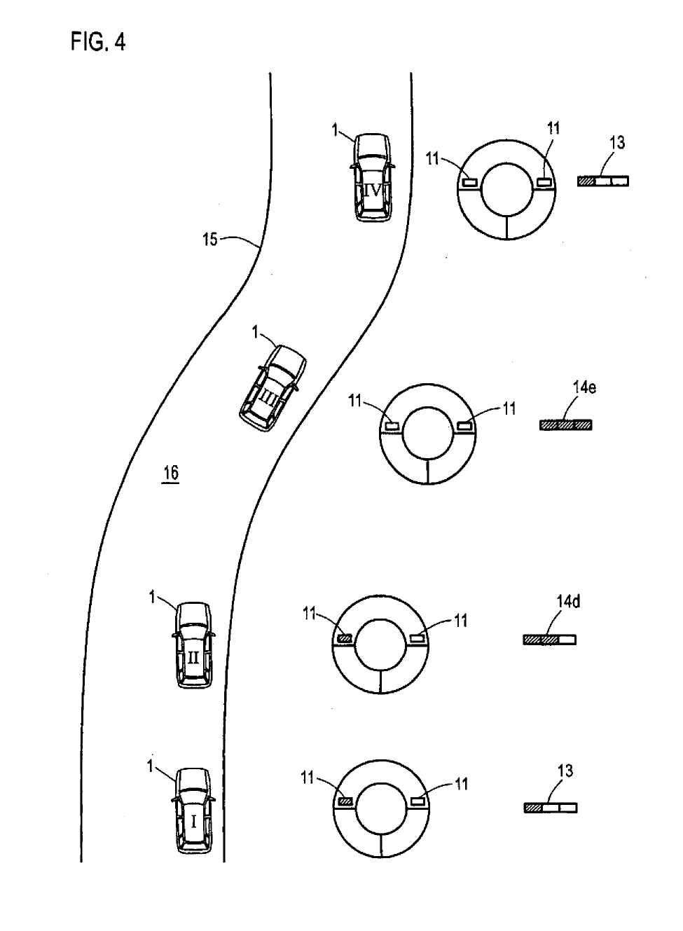

FIG. 4 is a sketch of the method according to the invention,

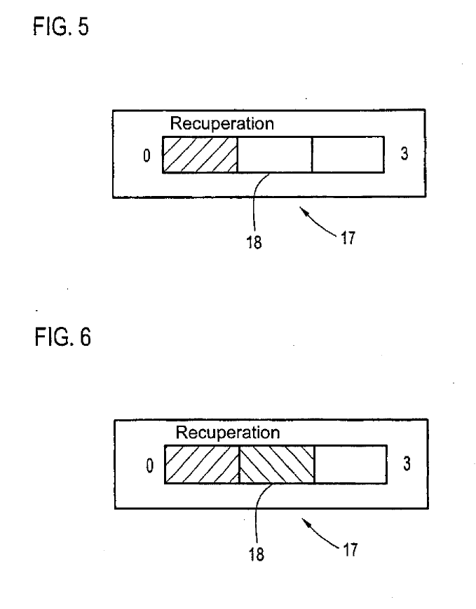

FIG. 5 is a recuperation display in a first state, and

FIG. 6 is a recuperation display in a second state.

FIG. 1 shows a schematic diagram of a motor vehicle 1 according to the invention, which has a hybrid drive schematically identified by 2. Thus, in addition to an internal combustion engine 3 an electric machine 4 is provided, which can be operated both as a generator and as a motor. During a coasting phase, that is when neither is actively braked nor the accelerator pedal is operated by the driver, it is now possible to use a certain recuperation torque in order to operate the electric machine 4 in the generational mode and to charge a battery 5 associated with the electric machine 4.

The operation of the hybrid drive 2 is controlled by a driving control device 6, which also determines the recuperation torque to use.

The drive control device 6 is connected via a vehicle bus, such as a CAN bus, with a man-machine interface 7 as a first operating element and two second operating elements 8 and also in connection with further, here only indicated vehicle systems 9

With the man-machine interface 7 an operating mode can be selected for example via a suitable menu by the driver, for example an energy saving mode, a normal mode, a sports mode, and a comfort mode. With each of this operating modes, in addition to other operating parameters, adjustments effecting the driving behavior of the vehicle 1, the basic value for the recuperation torque is associated. For example, for an energy-saving mode a recuperation torque of zero is assigned, as here a sailing operation is considered, for a comfort mode—a rather low recuperation torque, for a normal mode—a medium recuperation torque and for a sporty mode—a high recuperation torque. In this embodiment, the recuperation torque is thus switchable into four steps, which are also used in the inventive method.

The man-machine interface 7 thus acts as a first operating element, with which a basic value to be maintained can be adjusted for the recuperation torque. Also an intermediate freely selectable adjustment of the basic value for the recuperation torque can be realized with a corresponding adjustment menu. With this basic value for the recovery torque the electric machine 4 is usually controlled in a coasting phase in generator operation.

In order to enable a situational adjustment for a given driving situation, in addition to the man-machine interface 7 acting as first operating element, an arrangement of two second operating elements 8 is provided, which is particularly ergonomic and easy reachable for the driver, for spontaneously adapting the recuperation torque in a specific driving situation. In the present embodiment, as shown in FIG. 2, a steering wheel 10 in the vehicle 1 is provided, on which the both second operating elements 8 are realized as switching rockers 11 on a cross brace 12 of the steering wheel 10, so that they can be easily reached and operated by the fingers of the driver embracing the steering wheel 10. The elastic oppositely supported switching rockers 11 may be moved for example as a short switch lever or the like, which generate an actuation signal by touching. It should be noted at this point that, of course, other operating elements can be provided as the second operating elements, that are easily accessible by a driver, for example also switch or switch sticks on the steering wheel, a foot pedal and/or operating elements in the area of the gear selector lever.

Specifically, in this case it is now provided that by actuating of the left switching rocker 11 an intermediate value deviating from the basic value can be generated, that is increased compared to the basic value, while the right switching rocker 11 provides an intermediate value which is lower than the actual basic value. It should be noted at this point that, of course, if, as in this case, a certain number of predefined values or steps are present, at the highest step no increase is of course possible as well as the recuperation torque of course also can not fall below zero.

When it is especially relevant during an adjustment of recuperation torque that the effect of the actuation can also be experienced immediately when it should indeed be drawn to an actual or actual forthcoming traffic situation, the switching rockers 11 are actuatable only in presence of an adjustment condition, otherwise they are blocked and can not be used. As an adjustment condition in this case it is considered whether a coasting phase is already present or whether a coasting phase is possibly imminent. For this purpose the data of other vehicle systems 9 are evaluated, wherein predictive route data then can be analyzed, whether a curve soon approaches, sensor data of vehicles moving forwardly can be used so that with a clearly much slower moving vehicle in front, to conclude on a potentially upcoming coasting phase, and information is considered of upcoming speed limits, for example by means of a traffic sign recognition or map data of a navigation system to predict in this regard a potentially upcoming coasting phase.

If a coasting phase is present or if a coasting phase because of the surroundings of the vehicle is likely, the switching rockers 11 are actuated. The driver can now define an intermediate value, to be used temporarily for the current driving situation instead of the basic value for the recuperation torque. It should be noted at this point that, if in the following no coasting phase occurs, this selected adjustment according to a predetermined adjustment time, which here amounts to six seconds and corresponds later to a still to be discussed later latent time, expires again.

If already current a coasting phase is present or a coasting phase occurs within the adjustment time, then not the basic value for the recuperation torque is specified, but the drive control device 6 controls the electric machine 4 on the basis of the intermediate value. This intermediate value for the recuperation torque is maintained until the occurrence of a resetting condition, wherein in this case as resetting condition, the non-occurrence of a further coasting phase is used in the above-mentioned predetermined latent time after the end of a coasting phase. This means that a driver can interrupt a coasting phase for short periods without a result from it that the driving situation, for which he has chosen the intermediate value is already finished, when he joins another coasting phase within the latent time. However, if the resetting condition occurs, when in particular the latent time has elapsed without a further coasting phase, the basic value for the recuperation torque is set in the following again. The adjustment according to the intermediate value, which is performed by means of the switching rockers 11, is actually taken over only for the current driving situation.

In the present case by repeatedly pressing the switching levers 11 also a further intermediate value spaced from the basic value can be selected for the recuperation torque, but it can also be provided that only one stage may be deviated far from the basic value.

FIG. 3 shows an example of these possibilities, in which a medium recuperation torque is adjusted as a basic value 13. By appropriate actuation of the switching rockers 11, the intermediate values 14a (weak recuperation torque) and 14b (strong recuperation torque) may be achieved with single actuation. With a further actuation of the right switching rocker 11 also the intermediate value 14c (recuperation torque zero) can be achieved.

FIG. 4 shows the method of the invention now in a particular traffic situation. The motor vehicle 1 is shown in different positions I-IV on a street 15 which has a curve 16. This curve 16 is known from predictive route data, so that in the position I, the switching rockers 11 are unlocked, the actual adjusted recuperation torque corresponds to the basic value 3, here a weak recuperation torque. When the driver actuates the left switching rocker 11, as indicated in FIG. 4 at the Position I, the intermediate value 14d is obtained, when actually a coasting phase occurs within the adjustment time. This occurs at position II, so that there now the recuperation torque 14d is used. If the driver determines that he wants to increase the recuperation torque, he may, as indicated at position II, again actuate the left switching rocker 11 to adjust as a further intermediate value the intermediate value 14e (high recuperation torque), which already is used before this operation, and after this the motor vehicle 1 is already located in a coasting phase. This is shown during the continuance of the coasting phase in the position III again. In the position IV the motor vehicle is driven through the curve, and there was no further coasting phase for the latent time. This means that the recuperation torque is reset again to the basic value 13 and the switching rockers 11 are locked so they can not be actuated.

In the present embodiment, the actual adjustment regarding the recuperation torque is displayed to the driver in a multi-function display or an instrument panel. FIGS. 5 and 6 show a possible display. FIG. 5 shows a possible display 17 at the time when the motor vehicle 1 has held the position I. On a scale 18 the basic value 13 is seen, for example by backlighting a scale element in blue. FIG. 6 shows the display in the position II, where now on the scale 18 the intermediate value 14d is displayed. In this case, the display of the basic value remains in blue, while the temporary change, the intermediate value, is represented by a red backlighting of the middle scale segment.

Of course, other configurations are possible, for example those, in which two different scales are used or the like.

What is claimed is:

1.-12. (canceled)

13. A method of controlling a recuperation behavior in a motor vehicle with a hybrid drive or an electric drive, comprising:
adjusting by at least one first operating element a basic value of a recuperation torque which is to be used for the recuperation;
using a second operating element for adjusting an intermediate value deviating from the basic value;
after adjusting the intermediate value by an operator, using the intermediate value as the recuperation torque temporarily, at least for a next coasting phase; and
switching back to the basic phase when a resetting condition is entered.

14. The method of claim 13, further comprising using as the resetting condition a condition selected from the group consisting of an end of the coasting phase, a non-occurrence of a further coasting phase in a predetermined latent time after the end of the coasting phase, and both.

15. The method of claim 13, further comprising performing the adjusting of the intermediate value in a manner selected from the group consisting of performing the adjusting only in presence of an adjustment condition, maintaining the adjusting to the intermediate value only for a predetermined adjustment time, a duration of a next coasting phase which started within the adjustment time, already current coasting phase, and combinations thereof.

16. The method of claim 15, further comprising using as the adjusting condition a condition selected from the group consisting of a current presence of the coasting phase, an imminence of the coasting phase in a predetermined determination time, and a combination thereof.

17. The method of claim 16, further comprising carrying out the imminence of the coasting phase in dependence on data selected from the group consisting of predictive route date, data regarding a motor vehicle travelling ahead, data regarding a speed limit, and combinations thereof.

18. The method of claim 15, further comprising blocking an actuation of the second operating element in absence of the adjustment condition.

19. The method of claim 18, further comprising providing the blocking of the actuation of the second operating element by arresting the second operating element.

20. The method of claim 13, further comprising using as the second operating element an operating element which is arranged during driving in a position ergonomically accessible by a driver.

21. The method of claim 20, further comprising using as the second operating element the operating element selected from the group consisting of the operating element arranged in an area of a steering wheel, arranged on a switching lever, a foot pedal, and combinations thereof.

22. The method of claim 13, further comprising using as the second operating element an element selected from the group consisting of a switch, a switching lever on a steering wheel, a switching lever on a steering column, and combinations thereof.

23. The method of claim 22, further comprising using a pedal as the second operating element.

24. The method of claim 13, wherein the adjusting of the recuperation torque includes a gradual adjustment of the recuperation torque, with which only one intermediate value deviating by one step from the basic value can be adjusted.

25. The method of claim 13, further comprising performing the adjusting of the basic value with adjusting of an operating mode of the vehicle.

26. The method of claim 25, wherein the adjusting of the operating mode of the vehicle includes adjusting of the operating mode of the vehicle selected from the group consisting of a sports mode, a comfort mode, a normal mode, an energy-saving mode, and combinations thereof.

27. The method of claim 25, further comprising performing the adjusting of the basic value by freely selecting the basic value by a user.

28. The method of claim 25, further comprising performing the adjusting via a menu provided on a man-machine interface.

29. The method of claim 13, further comprising bringing an adjustment selected from the group consisting of the adjusting of the basic value, the adjusting of the intermediate value, and both to a driver for display.

30. A motor vehicle, comprising:
a hybrid drive or an electric drive;
a drive control device;
a first operating element for adjusting a basic value of a recuperation torque to be used for recuperation; and
a second operating element for adjusting an intermediate value for the recuperation torque, formed for carrying out a method according to claim 13.
